(19) United States
(12) Patent Application Publication
(10) Pub. No.: US 2008/0179772 A1
(43) Pub. Date: Jul. 31, 2008

(54) Method and Tool For Production of a Composite Chassis Piece For a Vehicle

(76) Inventors: Matthias Dichtl, Eurasburg (DE); Frank Kiesewetter, Germering (DE); Norbert Elbs, Munchen (DE)

Correspondence Address: DICKINSON WRIGHT PLLC, 1901 L. STREET NW, SUITE 800, WASHINGTON, DC, 20036, US

(21) Appl. No.: 11/909,374

(22) PCT Filed: Mar. 22, 2006
(86) PCT No.: PCT/DE2006/000518

§ 371 Date: Sep. 21, 2007

(30) Foreign Application Priority Data
Mar. 23, 2005 (DE) 10 2005 013 526.9

(51) Int. Cl. B29C 70/78; B29C 33/14

(52) U.S. Cl. 264/46.5; 264/266; 264/265; 264/229; 264/101; 264/162; 264/257; 264/46.4; 425/112; 425/111

(57) ABSTRACT

The invention relates to a method for production of a composite chassis piece (16, 28) for a motor vehicle, in particular, for production of a roof module in a tool (10), comprising a first (14) and a second tool part (12) which may be adjusted relative to each other. An outer skin (16) is laid in the first tool part, at least one part (24) of the circumferential region (22) of the side of the outer skin facing the first tool part is tightly inserted in a sealing arrangement (18) provided on the first tool part, plastic material (28) is applied to the side of the outer skin facing away from the first tool part, whereby a shaping of the plastic material is performed by the second tool part and the composite chassis piece is released from the seal arrangement and removed from the tool. The invention further relates to a corresponding tool.

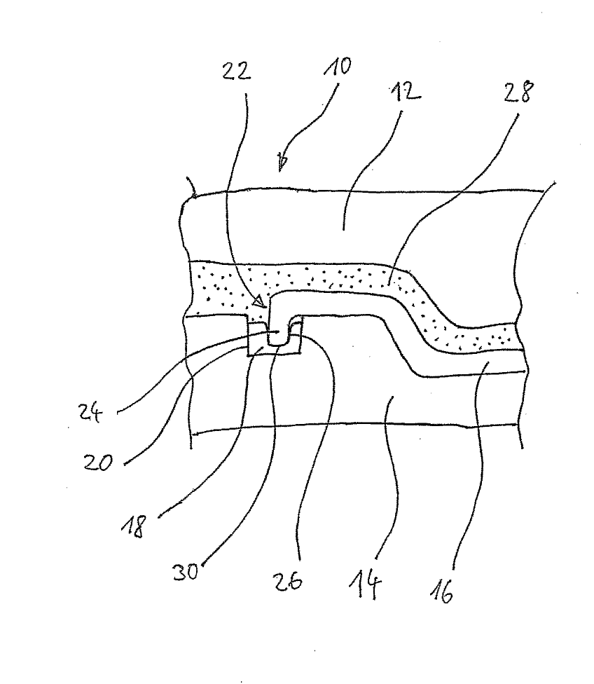

The present invention relates to a method and die mold for production of a composite chassis part for a motor vehicle, in particular for production of a roof module.

DE 101 63 709 A1 describes a roof module for a motor vehicle which can be positioned with its outside edges on a chassis frame and can be fixedly connected thereto. The roof module has an outer skin of steel plate or a plastic film which is backed with foam on its inside with a layer of plastic foam based on polyurethane. In a middle section the outer skin has an opening in which a transparent plate is provided, also being backed with a foam plastic layer on the underside of its circumferential edge area. Between the edge of the transparent plate and the edge of the opening, a gap is formed in the outer skin and is filled with foam plastic, this being done in such a manner that the outside of the roof module is planar in this area. This gap space is already filled in the foaming operation, with careful measures being taken in the foam mold to ensure that the gap between the outside surfaces of the outer skin and the transparent plate being filled only enough to form a smooth edge without any overlapping by the foam plastic. However this document does not mention how this requirement is to be taken into account.

DE 101 58 955 A1 describes a method for manufacturing a composite part with an outer skin of metal or plastic and with a foam plastic backing. A gasket is provided on the top part of the foam mold, forming a seal with the circumferential edge area of the inside of the outer skin in the foaming process to prevent the foam plastic from penetrating up to the edge on the inside of the outer skin.

DE 102 57 398 A1 describes a roof module in which an outer skin has a polyurethane backing, a gasket being attached to the bent edge area of the outer skin to seal the roof module with respect to the roof space in the condition in which the roof module is mounted on the motor vehicle. Whether the gasket has already been attached during the foaming process or is only attached thereafter is not described there.

The older German patent application with application number 10 2004 021 337 describes a method for producing a composite chassis part for a motor vehicle in which an outer skin of metal or plastic is backed with a foam plastic material on the inside and whereby the outside of the outer skin is brought in contact with a gasket provided on the lower part of the die mold by means of a vacuum created between the outer skin and the lower part of the die mold in order to prevent the plastic material from penetrating to the visible side, i.e., the outside of the outer skin. One disadvantage of this method is the relatively great lateral space required for the gasket, which is formed by two sealing lips arranged with a lateral offset, one after the other, and the low process reliability which derives first from the fact that the sealing arrangement may not be in complete contact with the outer skin when there are large tolerances in the shaping of the outer skin and may on the other hand be due to the fact that in the case of a foam backing, the outer skin is pressed between the two sealing lips, which may cause stress cracks in the outer skin.

The object of the present invention is to create a die mold for producing a composite chassis part, in particular a roof module, in which a high process reliability is to be achieved with a low demand for design space.

According to this invention, this object is achieved by a method according to Claim 1 and a die mold according to Claim 22. It is advantageous here that due to the fact that the outer skin is inserted with a sealing effect into a sealing arrangement provided for this purpose on the die mold over at least a portion of its circumferential edge area, there is first of all only a minor need for lateral space, while on the other hand, a high process reliability is achieved due to the fact that a high tolerance of the sealing function with respect to shaping tolerances in the outer skin is made possible and the risk of stress cracking in the outer skin due to forces acting from the inside of the outer skin in foam backing can be prevented. In particular, this eliminates the need for creating a vacuum between the outer skin and the part of the mold provided with the sealing arrangement. Furthermore, the inventive approach allows a great deal of freedom in terms of the design because sudden changes in the vertical direction of the roof (Z direction) can be implemented in the area to be sealed. Furthermore, savings in terms of material and costs are made possible with regard to the outer skin because roof openings, e.g., for installation of a sunroof, can be recessed in the outer skin from the beginning and need not be cut out subsequently when using the edge sealing of the outer skin according to the present invention.

Preferred embodiments of the present invention are derived from the subclaims.

The invention is explained in greater detail below on the basis of the accompanying drawing which shows as an example a schematic cross-sectional view of an outer skin inserted into a foam mold in its circumferential edge area.

The only FIGURE shows an area of a mold 10 comprising an top mold 12 and a bottom mold 14. The mold 10 may be opened and/or closed in the usual way by adjusting the top mold 12 and the bottom mold 14 in relation to one another. The FIGURE shows the mold 10 in a closed state.

At the start of the manufacturing process for a composite chassis part, in particular a roof module for a motor vehicle, an outer skin 16, which is made of a plastic film or a metallic material, e.g., sheet aluminum or steel plate, for example, is pre-shaped to the desired shape, e.g., by means of a deep drawing process. Then the pre-shaped outer skin 16 is inserted into the opened mold 10 and placed on the bottom mold 14 in such a way that the side of the outer skin which will subsequently form the outside of the chassis part, i.e., the visible side, is facing outward.

The bottom mold 14 is provided with a sealing arrangement 18 which is formed by a sealing profile arranged in a recess 20 in the bottom mold 14. At least a portion of the circumferential edge area 22 of the outer skin 16 is designed as section 24 which is bent toward the bottom mold 14, preferably by 90°, and inserted with a sealing effect into the sealing arrangement 18 from above when the outer skin is placed in the bottom mold 14. To this end, the sealing arrangement 18 is provided with a gap 26 which holds the bent section 24 of the outer skin 16 with a sealing effect when inserted.

In the simplest case, the sealing contact of the bent section 24 with the sealing arrangement 18 is created by an excess dimension of the gasket, whereby the sealing arrangement 18 undergoes elastic deformation on insertion of the bent section 24, and the bent section 24 is held by the resulting elastic forces in the sealing arrangement 18. Alternatively or additionally, the sealing arrangement 18 may be designed so that after insertion of the bent section 24 it undergoes elastic deformation due to external forces to hold the bent section 24 in the sealing arrangement 18. Such external forces may be created, for example, by inflating the sealing arrangement 18 or by adjusting a slide valve.

According to one embodiment, the outer skin 16 may be designed so that it has a bent section 24 in its entire circumferential edge area 22, said dent section being inserted into the sealing arrangement 18.

According to an alternative embodiment, the outer skin 16 may be provided with a bent section 24 which is inserted into the sealing arrangement 18 only in one or more partial sections of its circumferential edge area 22, whereby the outer skin 16 is then applied sealingly to a sealing mechanism (not shown) provided on the bottom mold 14 in the other areas, for example, as described in the older German patent application having the application number 10 2004 021 337, already cited above. Optionally, a vacuum may be created between the outer skin 16 and the bottom mold 14 to accomplish the sealing contact of such unbent sections of the circumferential edge area 22. Under some circumstances, however, it may also be advantageous to create a vacuum for the sealing effect of the sealing arrangement 18.

The section 24 is bent in the pre-shaping step mentioned above before the outer skin 16 is inserted into the mold 10.

In the next step, a plastic material 28 is applied to the side of the outer skin 16 (i.e., the inside of the outer skin 16) which faces away from the bottom mold 14. If the plastic material 28 is introduced exclusively in molten form, the mold 10 must be closed in advance. The top mold 12 ensures shaping of the side of the plastic material 28 facing away from the outer skin 16, whereby the plastic material 28 is pressed or injected behind the outer skin 16 or is used as a backing for the outer skin 16. The plastic material 28 preferably has polyurethane as the main or exclusive component. The plastic material 28 is introduced into the mold 10 by means of a so-called long fiber injection method (LFI method). As an alternative, the plastic material may also be introduced into the die mold 10 as a PHC structure (paper honeycomb structure). This is a composite structure comprised of a paper honeycomb structure and a fiberglass mat impregnated with polyurethane. Optionally the polyurethane may also be applied by an LFI method, i.e., as a mixture of polyurethane and chopped long glass fibers, to form the polyurethane-impregnated fiberglass mat.

In the example shown here, the bottom mold 14 and/or the outer skin 16 are shaped in such a way that the plastic material 28 extends at least partially beyond the circumferential edge area 22 of the outer skin 16 and is shaped in this area by the surface of the bottom mold 14. This sealing arrangement 18 serves to prevent the plastic material 28 from penetrating beyond the edge 30 of the circumferential edge area 22 to the visible side of the outer skin 16.

After conclusion of the shaping of the plastic material 28 by the top mold 12 and the bottom mold 14, i.e., after sufficient hardening of the plastic material 28, the mold 10 is opened and the finished composite component can then be removed from the mold 10.

After removing the composite component from the mold 10, the bent section 24 of the circumferential edge area 22 is removed, preferably by milling.

The composite part is preferably a roof module for a motor vehicle which can be applied with its outer edges to a chassis frame, i.e., the roof crossbeams of the vehicle and fixedly connected thereto, e.g., by bonding with adhesive or by screw connection.

### LIST OF REFERENCE NUMERALS

10 die mold
12 bottom mold [sic; top mold (see FIGURE)]
14 top mold [sic; bottom mold]
16 outer skin
18 sealing arrangement
20 recess
22 circumferential edge area of 16
24 bent section of 22
26 gap in 18
28 plastic material
30 edge of 16

1. Method for producing a composite chassis part (16, 18) for a motor vehicle, in particular for production of a roof module in a die mold (10), comprising a first mold part (14) and a second mold part (12), which are adjustable in relation to one another, whereby an outer skin (16) is inserted into the first mold part, at least a part (24) of the circumferential edge area (22) of the side of the outer skin facing the first mold part is inserted with a seal into a sealing arrangement (18) provided on the first mold part, plastic material (28) is applied to the side of the outer skin facing away from the first mold part, shaping of the plastic material being ensured by the second mold part, and the composite chassis part is released from the sealing arrangement and removed from the mold.

2. Method according to claim 1, characterized in that the outer skin (16) is inserted into the sealing arrangement (18) along its entire circumferential edge area (22).

3. Method according to claim 1, characterized in that the outer skin (16) is inserted into the sealing arrangement (18) along only one or more partial sections (24) of its circumferential edge area (22), whereby the outer skin is placed with a seal onto the sealing mechanism provided on the first mold part (14) in the other portions of the circumferential edge area.

4. Method according to any one of the preceding claims, characterized in that the circumferential edge area (22) of the outer skin (16) is bent toward the first mold part (14) in the section(s) (24) inserted into the sealing arrangement.

5. Method according to claim 4, characterized in that the outer skin (16) is shaped before being inserted into the mold (10) to produce at least the section(s) (24) that are bent toward the first mold part (14).

6. Method according to claim 4 or 5, characterized in that the circumferential edge area (22) of the outer skin (16) is bent by approximately 90° toward the first mold part (14) in the section(s) (24) that is/are inserted into the sealing arrangement (18).

7. Method according to any one of claims 4 through 6, characterized in that each bent section (24) of the circumferential edge area (22) of the outer skin (16) is removed from the mold (10) after removing the composite chassis part from the mold.

8. Method according to claim 7, characterized in that the bent section(s) of the circumferential edge area of the outer skin is/are removed by milling.

9. Method according to any one of the preceding claims, characterized in that the sealing arrangement (18) has an excess dimension, whereby the sealing arrangement undergoes elastic deformation on insertion of the corresponding section (24) and/or the corresponding sections of the circumferential edge area (22) of the outer skin (16), and the outer skin is held in the sealing arrangement by the resulting forces.

10. Method according to any one of claims 1 through 8, characterized in that the sealing arrangement (18) undergoes elastic deformation due to external forces after insertion of the corresponding section (24) and/or the corresponding sections of the circumferential edge area (22) of the outer skin (16) to hold the outer skin in sealing arrangement.

11. Method according to claim 10, characterized in that the outer forces are created by inflating the sealing arrangement (18) or by adjusting a slide valve.

12. Method according to any one of the preceding claims, characterized in that the sealing arrangement (18) is provided with a gap (26) into which the corresponding sections (24) of the circumferential edge area (22) of the outer skin (16) is/are inserted.

13. Method according to any one of the preceding claims, characterized in that the first mold part (14) and/or the outer skin (16) is/are shaped in such a way that the plastic material (28) extends at least partially over the circumferential edge area (22) of the outer skin (16) and undergoes shaping in this area by the first mold part (14).

14. Method according to any one of the preceding claims, characterized in that a vacuum is generated at least in a partial area between the first mold part (14) and the outer skin (16).

15. Method according to any one of the preceding claims, characterized in that the outer skin (16) has plastic material (28) pressed, injected or used as a backing behind it in the mold (10).

16. Method according to any one of the preceding claims, characterized in that the plastic material (28) is introduced into the mold (10) by means of a long fiber injection method.

17. Method according to any one of the preceding claims, characterized in that the plastic material (28) is introduced into the mold in the form of a plastic-reinforced honeycomb structure.

18. Method according to claim 17, characterized in that the honeycomb structure is a paper honeycomb structure with an impregnated glass fiber mat impregnated with polyurethane.

19. Method according to claim 18, characterized in that the polyurethane is applied by means of a long fiber injection method.

20. Method according to any one of the preceding claims, characterized in that the first mold part (14) is at the bottom and the second mold part (12) is at the top.

21. Method according to any one of the preceding claims, characterized in that the outer skin (16) is designed as a plastic film or as a sheet of aluminum or steel plate.

22. Die mold for producing a composite chassis part for a motor vehicle, in particular for production of a roof module, having a first mold part (14) and a second mold part (12) that are adjustable in relation to one another, whereby the first mold part is shaped so that an outer skin (16) can be inserted and is provided with a sealing arrangement (18), so that at least a portion (24) of the circumferential edge area (22) of the side of the outer skin facing the first mold part can be inserted with a seal against the sealing arrangement, whereby the mold is provided with means for applying plastic material (28) to the side of the outer skin facing away from the first mold part, and whereby the second mold part is designed to ensure shaping of the plastic material.

23. Die mold according to claim 22, characterized in that the sealing arrangement (18) is designed as a profile arranged in a recess (20) of the first mold part (14).

24. Die mold according to claim 22 or 23, characterized in that the sealing arrangement (18) is provided with means for elastic deformation of the sealing arrangement due to external forces after insertion of the corresponding section (24) and/or the corresponding sections of the circumferential edge area (22) of the outer skin (16) in order to hold the outer skin in the sealing arrangement.

25. Die mold according to claim 22 or 23, characterized in that the sealing arrangement (18) is provided with a gap (26) into which the corresponding section(s) (24) of the circumferential edge area (22) of the outer skin (16) is or can be inserted.

26. Die mold according to any one of claims 22 through 25, characterized in that the first mold part (14) is provided with means for creating a vacuum in at least a partial area between the first mold part and the outer skin (16).

27. Die mold according to any one of claims 22 through 26, characterized in that the mold (10) is designed to produce the composite chassis part as a roof module which can be applied with its outside edges to a chassis frame and can be fixedly secured to it.
